(19) United States
(12) Patent Application Publication
(10) Pub. No.: US 2021/0293311 A1
(43) Pub. Date: Sep. 23, 2021

(54) SPLIT-TYPE NUT ASSEMBLY

(71) Applicant: Shanghai Moons? Electric Co., LTD., Shanghai (CN)

(72) Inventors: Kai ZENG, Shanghai (CN); Zhigan WU, Shanghai (CN); Yanmeng GUO, Shanghai (CN); Wufeng YUAN, Shanghai (CN); Guangyu LIU, Shanghai (CN)

(21) Appl. No.: 16/471,464

(22) PCT Filed: Sep. 14, 2018
(86) PCT No.: PCT/CN2018/105601

§ 371 Date: Jun. 19, 2019

(30) Foreign Application Priority Data
Jun. 12, 2018 (CN) 201810603296.4

(51) Int. Cl. F16H 25/20; F16H 25/24

(52) U.S. Cl. CPC F16H 25/2009; F16H 25/24

(57) ABSTRACT

The invention relates to a split-type nut assembly. The split-type nut assembly comprises a first nut and a second nut which are completely separated from each other. The first nut and the second nut have identical pitches and leads and are matched with each other or move relative to each other on a threaded shaft. Compared with the prior art, the split-type nut assembly has the advantages of being good in clearance elimination effect, long in service life, convenient to disassemble and the like.

### TECHNICAL FIELD

The invention relates to the field of motor structures, in particular to a split-type nut assembly.

### DESCRIPTION OF RELATED ART

Micro lead screws and micro nuts have been widely used in the motion control field. Due to the fact that nuts may become worn after being used for a period of time and that a clearance generated after the nuts are worn may result in positional errors when the motion direction of the nuts is changed, the primary issue that should be taken into consideration for improving the precision of screw pairs is how to eliminate these motion errors.

According to existing techniques, a spring through which two nuts having identical leads are connected in the axial direction is used to provide an axial pushing or pulling force for the nuts to overcome a load and to eliminate a clearance. However, such a solution has the drawback that when the nuts bear a large load, a reactive force will be applied to the axial spring and an anti-backlash system moves reversely, which in turn increase the errors.

Traditional nuts or anti-backlash nuts need to be screwed from an end of a threaded shaft when assembled and need to be unscrewed from the end of the threaded shaft when disassembled. However, after users assemble a whole screw pair on a machine or a mechanism, the end of the threaded shaft has usually already been connected to other mechanisms with a bearing or other components, and in this case, if the nuts break down after long-time operation, the users cannot easily disassemble these nuts, or the users have to take a long time to disassemble the whole mechanism connected with the screw pair and then to repair these broken nuts or to replace these broken nuts with new ones.

Upon retrieval, Chinese Utility Model Patent Publication No. CN204459040U discloses a novel torsion spring-based anti-backlash nut which comprises a lead screw, wherein the lead screw has an end connected with a thread at one end of a flange nut, an internal spline of the flange nut is matched and connected with an external spline of a split-type nut which can be freely adjusted. Compared with an anti-backlash structure adopting a ball screw, such anti-backlash structure is more practical and has higher precision. Meanwhile, most nuts are made from self-lubrication POM and are matched with T-shaped 303 stainless steel lead screws, thereby having a smaller weight and lower noise and being more applicable to automatic facilities having high noise and sanitation requirements, such as medical facilities and food processing facilities. However, due to the fact that a torsion spring is used for connecting two nuts to eliminate a clearance, the torsion spring-based anti-backlash nut is inapplicable on large-load occasions and is difficult to disassemble.

### BRIEF SUMMARY OF THE INVENTION

The objective of the invention is to overcome the defects of the prior art by providing a split-type nut assembly.

The following technical solution is adopted by the invention to fulfill the above objective.

A split-type nut assembly comprises a first nut and a second nut which are completely separated from each other. The first nut and the second nut have identical pitches and leads and are matched with each other or move relative to each other on a threaded shaft.

Preferably, the split-type nut assembly further comprises a connector, wherein the first nut and the second nut are connected in a semi-floating manner through the connector.

Preferably, the connector is an elastic element capable of generating an elastic force.

Preferably, the connector is a C-shaped ring provided with an opening.

Preferably, the connector is a clamp spring, a multi-turn coil spring, an O-shaped ring or a rubber ring, not provided with an opening.

Preferably, a notch is formed in the circumference of the first nut; and the second nut has two ends matched with the notch of the first nut in shape, and the second nut is clamped into the first nut in a radial direction of the notch.

Preferably, the first nut and the second nut are able to slide relative to each other in the radial direction of the notch.

Preferably, a mounting flange of the first nut and the second nut is provided with matching guide grooves or guide rails, and the first nut and the second nut slide relative to each other through the guide grooves or guide rails.

Preferably, the guide grooves or guide rails are circular, square or triangular.

Preferably, the first nut is larger than the second nut; or, the first nut is smaller than the second nut; or, the first nut is as larger as the second nut.

Preferably, the first nut is of an integral structure or a split-type structure, and no matter whether the first nut is of the integral structure or the split-type structure, the same effect is realized.

Preferably, the second nut is of an integral structure or a split-type structure, and no matter whether the second nut is of the integral structure or the split-type structure, the same effect is realized.

Compared with the prior art, the invention has the following advantages:

1. The clearance elimination effect of the split-type nut assembly can last for a long time. According to the principle of the invention, the two nuts which are completely separated from each other can be engaged in the radial direction of the threaded shaft under the effect of the connector, the two nuts will be engaged more and more tightly in the joint direction with wear aggravation, and therefore, the clearance elimination effect will not be reduced after long-time operation.

2. The split-type nut assembly can bear a load over 50N without generating an obvious clearance, so that system precision is hardly affected. The split-type nut assembly has great advantages against traditional structures.

3. The split-type nut assembly can be easily assembled and disassembled by users. When the split-type nut assembly is applied to the fields having high precision requirements, users can directly separate the nuts from a screw pair in the radial direction so as to disassemble or replace the nuts very easily, and costs are greatly reduced.

### BRIEF DESCRIPTION OF THE SEVERAL VIEWS OF THE DRAWINGS

FIG. 1 is a structural view of an embodiment adopting a connector of the invention;

FIG. 2 is a schematic diagram of relative movement of a first nut and a second nut of the invention;

FIG. 3 is a side view of a split-type nut assembly of the invention after the first nut and the second nut are assembled;

FIG. 4 is a schematic view of a notch of the first nut of the invention, wherein a represents the notch;

FIG. 5 is structural view of the first nut of the invention;

FIG. 6 is a structural view of the second nut of the invention;

FIG. 7 is a right view of the second nut of the invention, wherein b represents an internal thread;

FIG. 8(a) is a front view of the first nut and the second nut connected through circular guide grooves of the invention, wherein c represents the circular guide groove;

FIG. 8(b) is a perspective view of the first nut and the second nut connected through the circular guide grooves of the invention;

FIG. 9(a) is a front view of the first nut and the second nut connected through triangular guide rails of the invention, wherein d represents the triangular guide rail;

FIG. 9(b) is a perspective view of the first nut and the second nut connected through the triangular guide rails of the invention;

FIG. 10 is a schematic diagram of integral movement for clearance compensation of the nuts of the invention, wherein F represents the radial pressure, E1 represents integral movement for clearance compensation of the first nut, and E2 represents integral movement for clearance compensation of the second nut;

FIG. 11 is comparison diagram of system errors of the existing design and the solution of the invention caused by clearances generated after long-time operation;

FIG. 12 is a comparison diagram of system errors of the existing design and the solution of the invention caused by clearances generated under a heavy load;

FIG. 13 is disassembly diagram of the split-type nut assembly of the invention, wherein G represents the disassembly direction of traditional anti-backlash nuts, and H represents the radial disassembly direction of the invention.

Reference signs: 1, first nut; 2, second nut; 3, threaded shaft; 4, connector.

### DETAILED DESCRIPTION OF THE INVENTION

Technical solutions of embodiments of the invention are clearly and completely explained below in combination with the accompanying drawings. Apparently, the embodiments in the following description are only certain illustrative ones and not all possible ones of the invention. All other embodiments obtained by those ordinarily skilled in this field based on these illustrative ones without creative work should also fall within the protection scope of the invention.

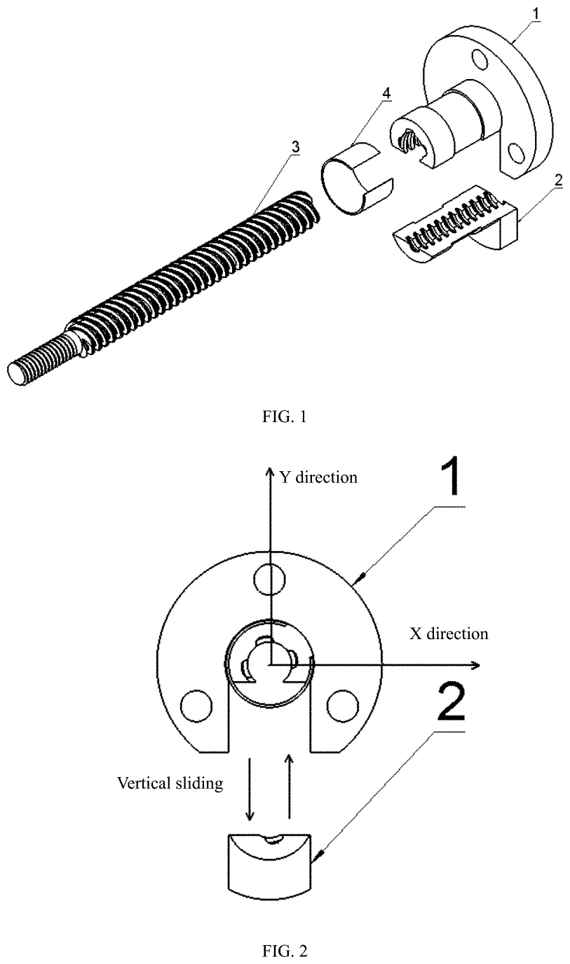

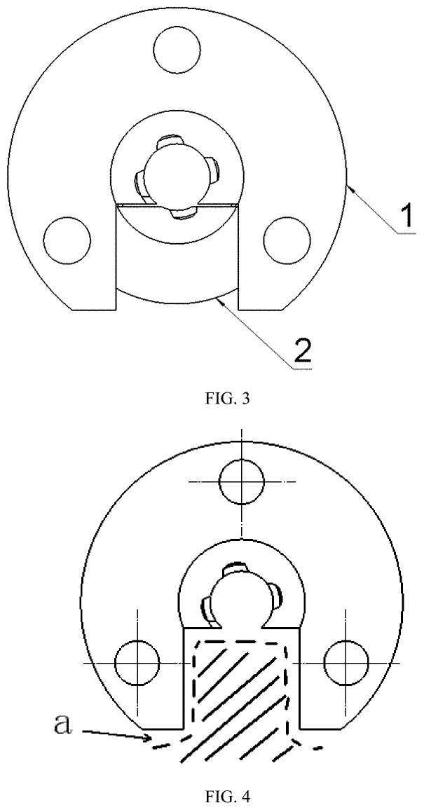

As shown in FIG. 1 and FIG. 3, a split-type nut assembly comprises a first nut 1 and a second nut 2 which are completely separated from each other. The first nut 1 and the second nut 2 have identical pitches and leads and are matched with each other or move relative to each other on a threaded shaft 3.

The split-type nut assembly further comprises a connector 4, wherein the first nut 1 and the second nut 2 are connected in a semi-floating manner through the connector 4.

The connector 4 is an elastic element capable of generating an elastic force. Preferably, the connector 4 is a C-shaped ring provided with an opening.

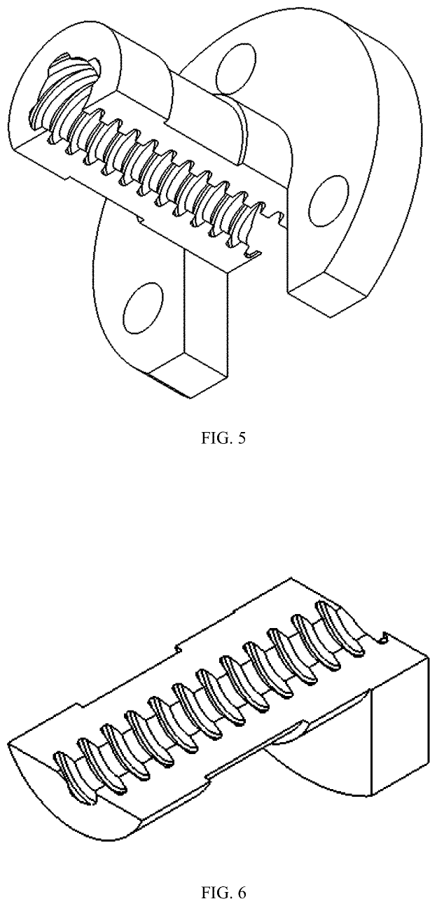

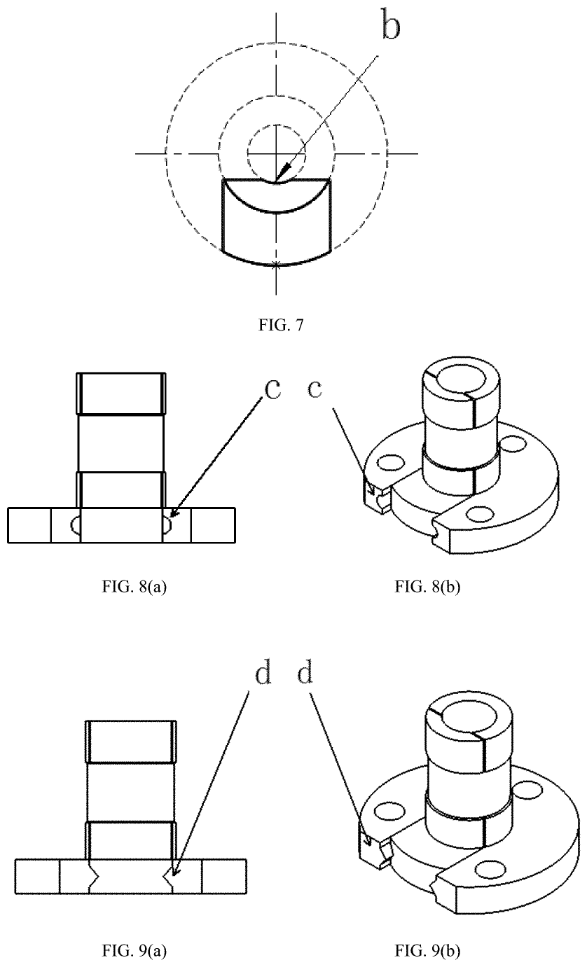

As shown in FIG. 4, FIG. 5, FIG. 6 and FIG. 7, the first nut 1 is not a complete circle when seen from the front, and a notch is formed in the circumference of the first nut 1; the second nut 2 is not a complete circle when seen from the front; and the second nut 2 has two sides matched with the notch of the first nut 1 in shape, so that the second nut 2 can be clamped into the first nut 1 in a radial direction of the notch.

As shown in FIG. 2, the first nut 1 and the second nut 2 are able to slide relative to each other in the radial direction of the notch.

A mounting flange of the first nut 1 and the second nut 2 is provided with matching guide grooves or guide rails.

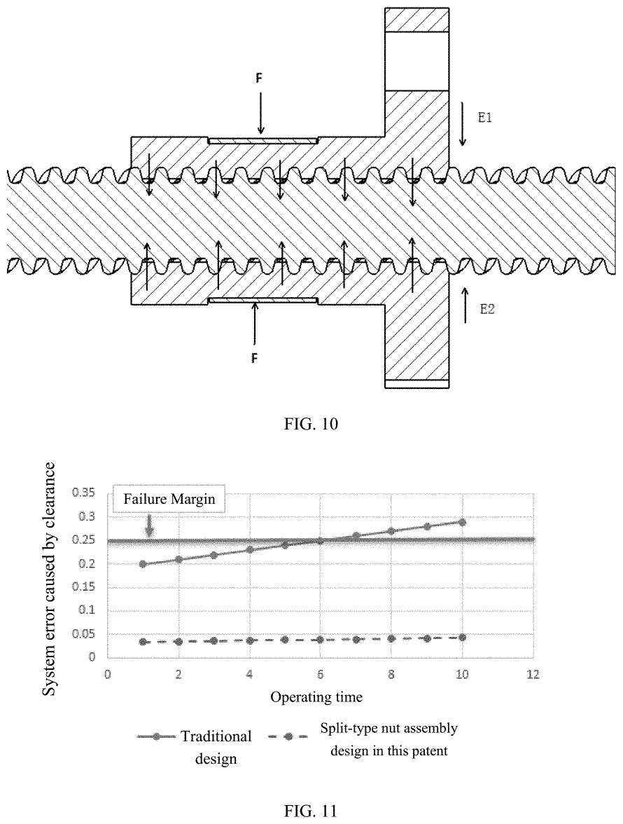

As shown in FIG. 8, circular guide grooves are adopted. As shown in FIG. 9, triangular guide rails are adopted.

As shown in FIG. 5 and FIG. 6, the first nut is larger than the second nut; or, the first nut is smaller than the second nut; or, the first nut is as large as the second nut.

Compared with traditional structures, the invention has the following advantages:

(1) The clearance elimination effect of the split-type nut assembly can last for a long time. When traditional anti-backlash nuts are worn after being used for a period of time, the clearance elimination effect will be greatly reduced under a heavy load due to the fact that the main clearance elimination direction is the axial direction. As shown in FIG. 10, according to the principle of this patent, the two nuts which are completely separated from each other can be engaged in the radial direction of the threaded shaft under the effect of the connector, the two nuts will be engaged more and more tightly in the Y direction with wear aggravation, and therefore, the clearance elimination effect will not be reduced after long-time operation. FIG. 11 shows the comparison of system errors of the existing design and the solution of the invention caused by clearances generated after long-time operation.

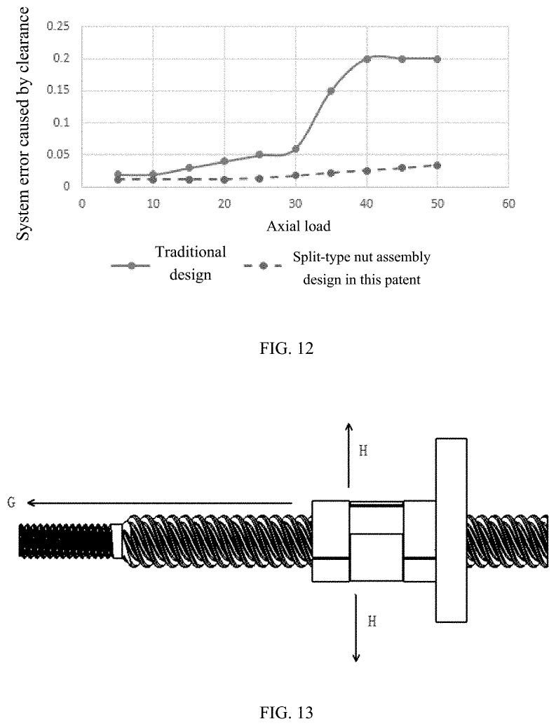

(2) The split-type nut assembly can bear a load over 50N without generating an obvious clearance, so that system precision is hardly affected. The split-type nut assembly has great advantages against traditional structures, as shown in FIG. 12.

(3) The split-type nut assembly can be easily assembled and disassembled by users. Traditional nuts or anti-backlash nuts need to be screwed from an end of a threaded shaft when assembled and need to be unscrewed from the end of the threaded shaft when disassembled. However, after users assemble a whole screw pair on a machine or a mechanism, the end of the threaded shaft has usually already been connected to other mechanisms with a bearing or other components, and in this case, if the nuts break down after long-time operation, the users cannot easily disassemble these nuts, or the users have to take a long time to disassemble the whole mechanism connected with the screw pair and then to repair these broken nuts or to replace these broken nuts with new ones. In contrast when the design of the invention is applied to the fields having high precision requirements, users can directly separate the nuts from a screw pair in the radial direction so as to disassemble or replace the nuts very easily, and costs are greatly reduced, as shown in FIG. 13.

The above embodiments are only specific ones of the invention and are not intended to limit the protection scope of the invention. Various equivalent modifications or substitutes easily achieved by those skilled in this technical field based on the technical contents of the invention should also fall within the protection scope of the invention. Therefore, the protection scope of the invention is subject to the protection scope defined by the claims.

1. A split-type nut assembly, comprising a first nut and a second nut which are completely separated from each other, wherein the first nut and the second nut have identical pitches and leads and are matched with each other or move relative to each other on a threaded shaft.

2. The split-type nut assembly according to claim 1, wherein the split-type nut assembly further comprises a connector, and the first nut and the second nut are connected in a semi-floating manner through the connector.

3. The split-type nut assembly according to claim 2, wherein the connector is an elastic element capable of generating an elastic force.

4. The split-type nut assembly according to claim 2, wherein the connector is a C-shaped ring provided with an opening.

5. The split-type nut assembly according to claim 2, wherein the connector is a clamp spring, a multi-turn coil spring, an O-shaped ring or a rubber ring, not provided with an opening.

6. The split-type nut assembly according to claim 1, wherein a notch is formed in a circumference of the first nut; and the second nut has two ends matched with the notch of the first nut in shape, and the second nut is clamped into the first nut in a radial direction of the notch.

7. The split-type nut assembly according to claim 6, wherein the first nut and the second nut are able to slide relative to each other in the radial direction of the notch.

8. The split-type nut assembly according to claim 1, wherein a mounting flange of the first nut and the second nut is provided with matching guide grooves or guide rails, and the first nut and the second nut slide relative to each other through the guide grooves or guide rails.

9. The split-type nut assembly according to claim 8, wherein the guide grooves or guide rails are circular, square or triangular.

10. The split-type nut assembly according to claim 1, wherein the first nut is larger than the second nut; or, the first nut is smaller than the second nut; or, the first nut is as larger as the second nut.

11. The split-type nut assembly according to claim 1, wherein the first nut is of an integral structure or a split-type structure, and no matter whether the first nut is of the integral structure or the split-type structure, a same effect is realized.

12. The split-type nut assembly according to claim 1, wherein the second nut is of an integral structure or a split-type structure, and no matter whether the second nut is of the integral structure or the split-type structure, a same effect is realized.
